(19) United States
(12) Patent Application Publication
(10) Pub. No.: US 2011/0055512 A1
(43) Pub. Date: Mar. 3, 2011

(54) TAPE FEEDER, REMOVABLE UNIT FOR ELECTRONIC COMPONENT MOUNTING, AND ELECTRONIC COMPONENT MOUNTING APPARATUS

(75) Inventors: Akifumi Wada, Fukuoka (JP); Atsuyuki Horie, Fukuoka (JP)

(73) Assignee: PANASONIC CORPORATION, Osaka (JP)

(21) Appl. No.: 12/863,259

(22) PCT Filed: Jan. 9, 2009
(86) PCT No.: PCT/JP2009/000079

§ 371 Date: Jul. 16, 2010

(30) Foreign Application Priority Data
Jan. 21, 2008 (JP) P2008-010115

(51) Int. Cl. G06F 12/06

(52) U.S. Cl. 711/170; 711/E12.084

(57) ABSTRACT

To provide a tape feeder and an electronic component mounting apparatus that enables easy, reliable recognition of a model of an individual subjected to a specification change after factory shipment.

A storage unit 20 of a feeder control unit 8 includes a first memory area 21 for storing a code (model code) pertaining to a model of a tape feeder 2 at factory shipment along with a serial code showing an individual of the tape feeder 2 and a second memory area 22 for storing a code (a specification change code) pertaining to a change made to specifications of the tape feeder 2 after factory shipment. The second memory area is empty at factory shipment. Every time a change is made to specifications with elapse of a time after factory shipment, a new code is additionally stored in the second memory area.

### TECHNICAL FIELD

The present invention relates to a tape feeder including a storage unit for storing information required to recognize a model, a removable unit for electronic component mounting, and an electronic component mounting apparatus including the tape feeder or the removable unit for electronic component mounting.

### BACKGROUND ART

A tape feeder stores a code for use in recognize a model in a built-in storage unit. An electronic component mounting apparatus equipped with the tape feeder accesses the storage unit and reads the code, thereby recognize a model of the tape feeder. Based on the recognized model, the electronic component mounting apparatus controls operation of the electronic component mounting apparatus including the tape feeder (see Patent Document 1).

Patent Document 1: JP-A-2006-012957

### DISCLOSURE OF THE INVENTION

### Problems to be Solved by the Invention

In the storing unit, a code pertaining to factory specifications is stored along with a serial number showing an individual. However, a user does not necessarily use the tape feeder while keeping the factory specifications intact. There are many instances where the tape feeder is modified in conformance with a user environment, e.g., specification changes, such as replacement of a part to another part conforming to micro-components. When a model of the individual subjected to a specification change after factory shipment as mentioned above is recognized in accordance with a code pertaining to a factory specification, the model is recognized by specifications differing from the current specifications, which sometimes hinders operation control of the electronic component mounting apparatus. A conceivable method is to manually input a change to the electronic component mounting apparatus by means of a code input in relation to a tape feeder whose specifications have been changed. However, the method presents drawbacks, i.e., complication of operation and a growing likelihood of occurrence of human error.

Accordingly, an object of the present invention is to provide a tape feeder, a removable unit for electronic component mounting, and an electronic component mounting apparatus that enable easy, reliable recognition of a model of an individual subjected to a specification change after factory shipment.

### Means for Solving the Problems

A tape feeder according to a first aspect of the present invention is a tape feeder including a storage unit configured to store codes for recognizing a model, wherein the storage unit includes a first memory area for storing a code pertaining to a model of the tape feeder at factory shipment and a second memory area for storing a code pertaining to a change made to specifications after factory shipment.

An electronic component mounting apparatus according to a second aspect of the present invention is an electronic component mounting apparatus which is equipped with the tape feeder of the first aspect and is configured to recognize the model of the tape feeder in accordance with the codes stored in the storage unit, wherein if the code pertaining to the change made to the specifications after factory shipment is stored in the second memory area, the model of the tape feeder is recognized according to the codes respectively stored in the first memory area and the second memory area.

A removable unit for electronic component mounting according to a third aspect of the present invention is a removable unit for electronic component mounting including a storage unit configured to store codes for recognizing a model, wherein the storage unit includes a first memory area for storing a code pertaining to a model of the removable unit for electronic component mounting at factory shipment and a second memory area for storing a code pertaining to a change made to specifications after factory shipment.

An electronic component mounting apparatus according to a fourth aspect of the present invention is an electronic component mounting apparatus which is equipped with the removable unit for electronic component mounting of the third aspect and is configured to recognize the model of the removable unit for electronic component mounting in accordance with the codes stored in the storage unit, wherein if the code pertaining to the change made to the specifications after factory shipment is stored in the second memory area, the model of the removable unit for electronic component mounting is recognized according to the codes respectively stored in the first memory area and the second memory area.

### ADVANTAGES OF THE INVENTION

According to the present invention, it is possible to store a code pertaining to a change made to specifications of a removable unit for electronic component mounting after factory shipment in a storage unit that stores a code for recognizing a model. Consequently, on occasion of recognition of a model of a removable unit for electronic component mounting, a higher level system, such as an electronic component mounting apparatus, can recognize a model including specifications changed after factory shipment.

### BRIEF DESCRIPTION OF THE DRAWINGS

FIG. 1 is a schematic diagram of an electronic component mounting apparatus according to an embodiment of the present invention.

FIG. 2 is a block diagram of a control system of the electronic component mounting apparatus of the embodiment of the present invention.

### DESCRIPTION OF REFERENCE CHARACTERS

1: electronic component mounting apparatus

2: tape feeder

20: storage unit

21: first memory area

22: second memory area

### BEST MODE FOR CARRYING OUT THE INVENTION

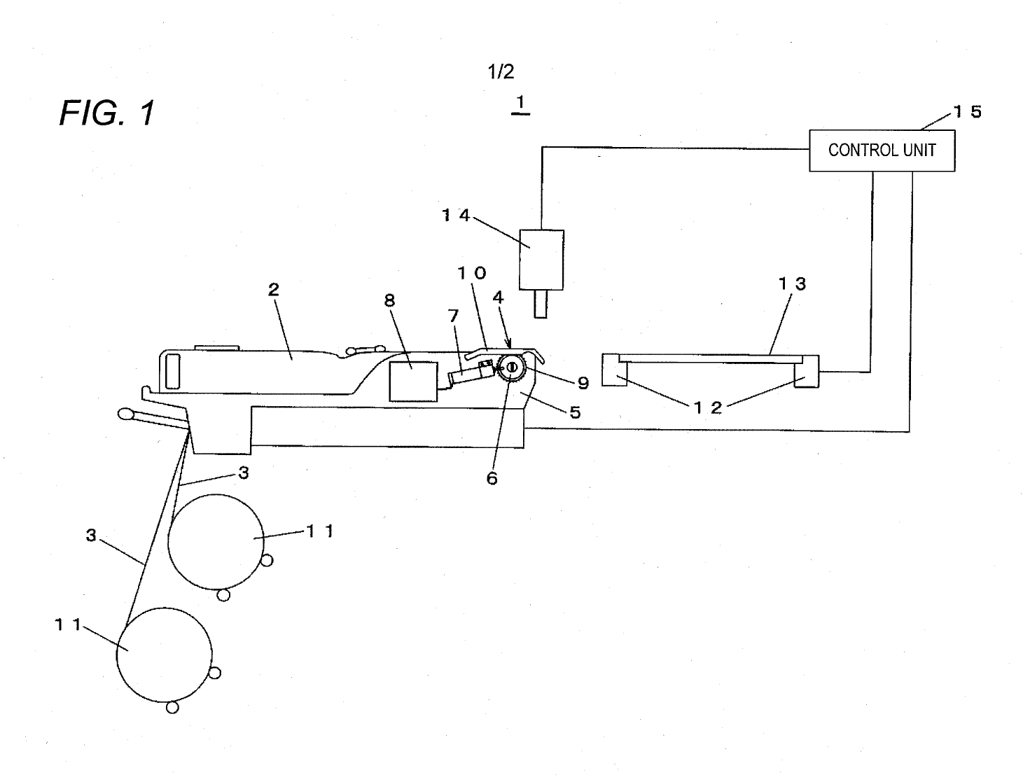

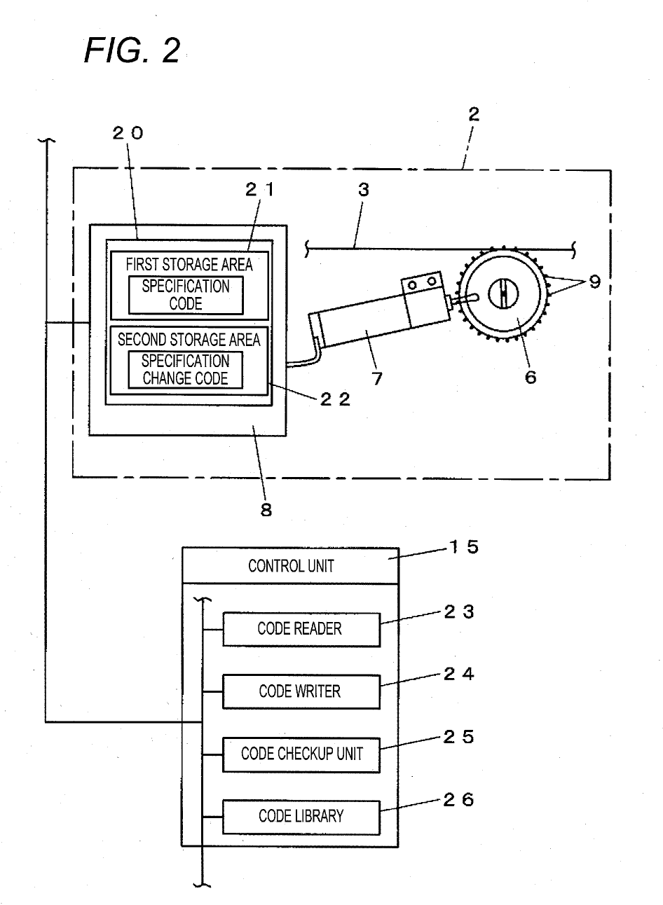

An embodiment of the present invention is described by reference to the drawings. FIG. 1 is a schematic diagram of an electronic component mounting apparatus according to an embodiment of the present invention, and FIG. 2 is a block diagram of a control system of the electronic component mounting apparatus. In FIG. 1, an electronic component mounting apparatus 1 includes an electronic component feeding unit, a substrate holding unit, a transfer head, and a control unit. The electronic component feeding unit is equipped with a tape feeder 2. The tape feeder 2 has a function of feeding a carrier tape 3 in one direction and forwarding a plurality of electronic components, which are housed in the carrier tape 3 at uniform intervals in a feeding direction, one piece at a time to a component pickup port 4.

A sprocket 6, a motor 7 imparting rotation to the sprocket 6, and a feeder control unit 8 that controls driving of the motor 7 are arranged in a housing 5 of the tape feeder 2. Pins 9 are provided along an outer periphery of the sprocket 6 and engage with sprocket holes (omitted from illustrations) of the carrier tape 3, whereupon the carrier tape 3 is fed. A openable and closable tape press cover 10 is provided at a location where the sprocket holes of the carrier tape 3 engage with the pins 9. Operation for letting the sprocket holes of the carrier tape 3 engage with the pins 9 is performed by opening the tape press cover 10. When closed, the tape press cover 10 exhibits a function of pressing the carrier tape 3 against the sprocket 6. The pins 9 and the sprocket holes of the carrier tape 3 are thereby held in an engaged state during operation of the tape feeder 2, so that feeding of the carrier tape 3 can be performed without a problem. A portion of the tape press cover 10 is opened as the component pickup port 4 for extracting an electronic component from the carrier tape 3.

The carrier tape 3 is wound around a reel 11 outside the housing 5 and introduced into the housing 5 from the back of the tape feeder 2 in conjunction with rotation of the sprocket 6. The feeder control unit 8 controls driving of the motor 7 such that the sprocket 6 is intermittently rotated. The carrier tape 3 is thereby fed such that the plurality of electronic components stored at uniform intervals on the carrier tape 3 sequentially come to the component pickup port 4 one at a time.

The substrate holding unit has a function of stopping a substrate 13 conveyed by carrier rails 12 at a predetermined position and holding the thus-stopped substrate at that position. A transfer head 14 travels between the tape feeder 2 and the substrate 13 held at the predetermined position back and forth, adsorbs to take an electronic component out of the component pickup port 4, and mounts the electronic component at a predetermined location on the substrate 13. A control unit 15 controls operation of the tape feeder 2, the carrier rails 12, and the transfer head 14.

In FIG. 2, a memory unit 20 of the feeder control unit 8 includes two memory areas. A first memory area 21 is an area for storing a code (a model code) pertaining to a model of the tape feeder 2 at factory shipment and a serial code showing an individual of the tape feeder 2. The second memory area 22 is an area for storing a code (a specification change code) pertaining to a change made to specifications of the tape feeder 2 after factory shipment. The tape feeder 2 passed into the possession of the user after factory shipment is not necessarily, continually used while factory specifications of the tape feeder remain unchanged. There are cases where modifications commensurate with a use environment, e.g., changes to size and shape of the component pickup port 4 in conformance with a micro-component, are required. In this case, there is made a specification change, such as replacement of the tape press cover 10 attached to the tape feeder at the time of factory shipment with another tape press cover including a component pickup port in a desired size and shape. A code showing a tape press cover acquired after replacement is written into the storage unit 20, and the thus-written code is stored in the second memory area 22 as a specification change code. The second memory area remains empty area at the time of factory shipment. Every time a change is made to specifications of the tape feeder in the course of elapse of a time after factory shipment, a new code is additionally stored.

The control unit 15 includes a code reader 23, a code writer 24, a code checkup unit 25, and a code library 26. The code reader 23 reads a model code and a specification change code stored in the storage unit 20. The code writer 24 writes the specification change code into the second memory area of the storage unit 20. The code checkup unit 25 checks the model code and the specification change code read by the code reader 23 against library information in the code library 26.

When the tape feeder 2 is set on the electronic component mounting apparatus 1, whereby they are electrically connected with each other. The code reader 23 belonging to the electronic component mounting apparatus 1 reads the code from the storage unit 20 of the tape feeder 2. The model code is always stored in the first memory area. However, when no change is made to the specifications after factory shipment, nothing is stored in the second memory area 22. Therefore, the code reader 23 reads the model code and the specification change code from the tape feeder 2 whose specifications have been changed. The model code is read from the tape feeder 2 having undergone no specification change.

The control unit 15 checks the code read from the storage unit 20 by the code reader 23 against library information in the code library 26 by means of the code checkup unit 25, thereby recognizing a model of the tape feeder 2. Since the model of the tape feeder 2 whose specifications have been changed is checked according to a model code and a specification change code, operation control conforming to current specifications of the tape feeder 2 subjected to a specification change can be performed. For instance, in the case of the tape feeder 2 in which a tape press cover is replaced with a tape press cover having a component pickup port that conforms to a micro-component in size and shape, the tape feeder cannot be handled as a normal component envisaged by factory specifications. Therefore, operation control taking into account the situation is performed.

Many conceivable types of changes made to specifications after factory shipment are changing of a member or a mechanism associated with miniaturization of components to be handled, like the foregoing tape press member. However, the present invention is not limited to such a type of change. The present invention is applicable to a situation in which operation control of an electronic component mounting apparatus will be affected by changing of factory specifications of the tape feeder 2 after shipment.

The tape feeder is exemplified in the embodiment as an example of the removable unit for electronic component mounting, but the removable unit for electronic component mounting is not limited to the tape feeder. A variety of units, such as a removable mounting head, an inspection head, a print head, a coating head, and a robot hand, can be adopted as the removable unit for electronic component mounting.

The present invention is also expected to be subjected to various modifications and applications by the persons skilled in the art according to the descriptions of the present patent application and well-known techniques without departing from the spirit and scope of the present invention. The modifications and applications shall fall within a scope where protection of the present invention is sought.

The present patent application is based on Japanese Patent Application (Application No. 2008-010115) filed on Jan. 21, 2008, the entire contents of which are incorporated herein by reference.

### INDUSTRIAL APPLICABILITY

When a higher-level system, such as an electronic component mounting apparatus, recognizes a model of a removable unit for electronic component mounting, it is possible to recognize a model including specifications changed after factory shipment.

1. A tape feeder comprising:
a storage unit configured to store codes for recognizing a model,
wherein the storage unit includes a first memory area for storing a code pertaining to a model of the tape feeder at factory shipment and a second memory area for storing a code pertaining to a change made to specifications after factory shipment.

2. An electronic component mounting apparatus which comprises the tape feeder according to claim 1 and is configured to recognize the model of the tape feeder in accordance with the codes stored in the storage unit,
wherein if the code pertaining to the change made to the specifications after factory shipment is stored in the second memory area, the model of the tape feeder is recognized according to the codes respectively stored in the first memory area and the second memory area.

3. A removable unit for electronic component mounting comprising:
a storage unit configured to store codes for recognizing a model,
wherein the storage unit includes a first memory area for storing a code pertaining to a model of the removable unit for electronic component mounting at factory shipment and a second memory area for storing a code pertaining to a change made to specifications after factory shipment.

4. An electronic component mounting apparatus which comprises the removable unit for electronic component mounting according to claim 3 and is configured to recognize the model of the removable unit for electronic component mounting in accordance with the codes stored in the storage unit,
wherein if the code pertaining to the change made to the specifications after factory shipment is stored in the second memory area, the model of the removable unit for electronic component mounting is recognized according to the codes respectively stored in the first memory area and the second memory area.
